(19) United States
(12) Patent Application Publication
(10) Pub. No.: US 2007/0008924 A1
(43) Pub. Date: Jan. 11, 2007

(54) Device to facilitate the deployment of mobile virtual private networks for medium/large corporate networks

(76) Inventor: Padraig Moran, Upplands Vasby (SE)

Correspondence Address: POWELL GOLDSTEIN LLP, ONE ATLANTIC CENTER, FOURTEENTH FLOOR 1201 WEST PEACHTREE STREET NW, ATLANTA, GA, 30309-3488, US

(21) Appl. No.: 10/597,134

(22) PCT Filed: Jan. 17, 2005
(86) PCT No.: PCT/SE05/00040

§ 371 Date: Jul. 12, 2006

Related U.S. Application Data
(60) Provisional application No. 60/536,492, filed on Jan. 15, 2004.

(51) Int. Cl. H04Q 7/00

(52) U.S. Cl. 370/331

(57) ABSTRACT

A mobile agent device in a Mobile Virtual Private Network, said device comprising: termination of Mobile IP tunnel (6) from a remotely connecting Mobile Node (1); termination of an IPSec VPN tunnel (7) from the remotely connecting Mobile Node; dynamic Selection of Internal Mobile IP Home Agent based on user Authentication; tunneling of traffic to and/or from the assigned Internal Mobile Home Agent for this Mobile Node; and, provision of extended authentication, after Mobile IP connection establishment, and during the VPN negotiation phase, based on extra user credentials, one-time-password mechanism or similar.

### FIELD OF INVENTION

The present invention relates to mobile data communication in general. More specifically, the present invention describes a device whereby seamless, secure mobility can be provided in a scalable manner, deployable for larger enterprises, offering near-optimal traffic flows for mobile users moving inside and enterprise, inside to outside and vice-versa. The invention is based on the use of the Mobile IP and IKE/IPSec protocols, and the development of a Transfer Home Agent device, encompassing aspects of the functionality of the Home Agent and Foreign Agent from the Mobile IP specification, while incorporating VPN gateway functionality for remotely connecting mobile users.

### BACKGROUND AND SUMMARY OF THE INVENTION

The following definitions are introduced for the purposes of clarity:

FA Foreign Agent: The primary responsibility of an FA is to act as a tunnel agent which establishes a tunnel to a HA on behalf of a Mobile Node in mobile IP.

HA Home Agent: The primary responsibility of the HA is to act as a tunnel agent which terminates the mobile IP tunnel, and which encapsulates datagrams to be sent to the Mobile Node in mobile IP.

I-HA Internal Home Agent: This is a HA deployed internally within the corporate intranet, providing a mobility anchor point for a mobile node when it is within the intranet, and also connected directly to the mobile node's home network.

I-HA intranet IP address: This is the IP address that the T-HA accesses the I-HA for forwarding mobile IP control messages and encapsulated traffic towards.

I-HA private IP address: This is the IP address that the I-HA has configured on the interface connected on the Home Network.

IETF Internet Engineering Task Force: The IETF is the standardization organization for the Internet community.

M-VPN Mobile VPN: This is the provision of the Virtual Private Network (VPN) over a Mobile IP solution, providing seamless mobility for user traffic, as the mobile node moves between different access networks, both inside and outside an enterprise network, yet providing VPN-level security and encryption during this mobility.

IP Internet Protocol: IP is a network layer protocol according to the ISO protocol layering. IP is the major end-to-end protocol between Mobile and Fixed End-Systems for Data Communications.

MIPMobile IP: MIP is an IP mobility standard being defined by the IETF with the purpose to make IP networks mobility aware, i.e. providing IP entities knowledge on where a Mobile Node is attached to the network. The standard includes the definition of a Foreign Agent and a Home Agent.

MN Mobile Node: The MN comprises both the Terminal Equipment (TE) and the Mobile Termination (MT). A Remotely Connecting MN refers to a MN connecting to the enterprise from outside the intranet, i.e. from the Internet.

NAI Network Access Identifier: An identifier that uniquely identifies the Mobile Node. It consists of two parts, a user name and a realm part separated by a @-sign, e.g. john.doe@bigoperator.inc

RRQ Mobile IP Registration Request: Mobile IP control message sent when a Mobile Node is request registration from a new location away from its home network.

OTP One Time Password: An authentication mechanism whereby some synchronization between a client and an authentication server allows the user to be authenticated by entering a different ‘one-time’ pass phrase each time he connects.

RRP Mobile IP Registration Reply: Mobile IP control message sent from a Mobile IP Agent in response to a RRQ. This will indicate a success or failure of the registration and appropriate user settings.

RFC Request For Comment: The collective name of standard documents produced within the IETF. Each standard document starts with RFC and a number, e.g. RFC2794 is the standard for Network Access Identifier for Mobile IPv4.

T-HA Transfer Home Agent: The primary responsibility of the T-HA is to provide HA functionality and a VPN termination for a remotely connecting MN. The T-HA acts as a transfer agent, forwarding appropriate traffic onwards to an internally located (inside enterprise network) HA or routing it towards its final destination, and transferring return traffic from the HA to the MN, dealing with appropriate encapsulation, encryption, authentication and accounting.

T-HA public IP address: This is the IP address used by the remotely connecting MN when registering towards the T-HA. This is the publicly accessible IP address for the T-HA.

Mobile IP defines a Home Agent as the anchor point with which the Mobile Node always has a relationship, and a Foreign Agent, which acts as the local tunnel-endpoint at the access network where the Mobile Node is visiting. While moving from one IP sub network to another, the Mobile Node point of attachment (FA) may change. At each point of attachment, mobile IP either requires the availability of a standalone Foreign Agent or the usage of a co-located care-of address in the Mobile Node itself in the case that no Foreign Agent is available. From remote locations, tunnels are established, either directly from the Mobile Node or via a FA, back to the HA, hiding any address changes due to connectivity changes, from active applications. When a Mobile Node moves onto its Home Network, it de-registers with its HA, which must be no more than 1 router hop away, and proceeds to send traffic out on the home network, without any tunneling. Tunneling is not required as the MN IP address is in the subnet of the home network.

In a Mobile VPN solution where Mobile IP is combined with a VPN technology, a Home Agent typically acts as a VPN gateway for protection of user traffic, while also providing the Mobile IP HA functionality. Typically this has resulted in the HA being placed in a location at the edge of the enterprise, typically in the DMZ, allowing termination of VPN traffic from remotely connecting mobile nodes, while also providing a mobility anchor point for these mobile nodes.

The requirement, in Mobile IP, for a home network to be no more than one router hop from the HA means that deploying a Mobile VPN solution in a routed, or multi-site, enterprise network may result in tunneling from within the enterprise intranet back to the HA and back to the intranet again, even when a user is on what would be considered its home network. This results in sub-optimal traffic flows, and substantial tunneling overhead.

An alternative approach would be to deploy M-VPN devices (terminating VPN and providing HA functionality) physically connected to each home network, thereby facilitating optimal traffic flows. This approach introduces unwanted security side-effects, requiring VPN traffic to be terminated potentially long inside the intranet, and conflicting with the requirement of many enterprises to filter all incoming traffic, and have a single point of access to and from the Internet.

The invention described herein defines a new mobile agent device called a Transfer Home Agent (T-HA), providing mobile agent and VPN functionality, which can be the placed at the edge of the enterprise network, thus addressing the security concerns while still providing an anchor point for remote mobility. This device will, when combined with an internally deployed HA, connected to one or more internal home networks, provide full mobility between internal and external networks, and also facilitate optimal traffic flows for a mobile node connected on its home network

### SUMMARY OF INVENTION

The present invention defines a mobility device, called a Transfer Home Agent (T-HA), providing the following main functionalities:
Acts as a VPN termination point for a remotely connecting mobile node (MN), where IPSec VPN connections are used.
Appears as a mobile IP HA for these remotely connecting mobile nodes, providing support for processing of mobile IP control messages, and termination of mobile IP encapsulated tunnels. In this way the mobile node communicates only with the T-HA when connecting remotely.
Supports dynamic assignment of an internal HA (I-HA) to be used by the connecting mobile node to facilitate full seamless mobility when moving from remote public access to internal (on the home network in inside the intranet) access, and vice-versa.
Appears as a mobile IP foreign agent (FA) when communicating with the I-HA, facilitating deployment of standards-compliant HAs.
Provides for forward tunneling (from T-HA to I-HA) of traffic, or plain IP routing of from the remotely connecting mobile node, allowing incoming traffic to still benefit from enterprise firewall and security protection.
Provides IP or UDP encapsulated tunnel termination point for tunneling of traffic from the I-HA, destined for the remotely connecting Mobile Node.
Acts as a tunnel transfer point, decrypting and de-capsulating traffic from the MN and encapsulating traffic towards the I-HA (or forwarding directly to destination), and vice-versa.

The deployment of the T-HA, on the enterprise edge, when combined with internal home agents, within the enterprise intranet, facilitates the provisioning of a mobile VPN solution whereby the VPN termination is carried out at the edge of the network and seamless mobility is provided for the mobile node when moving outside the intranet, inside intranet or between the two, where the intranet is either a routed (multi-hop) network or multi-site network, and VPN traffic is required to be terminated at the edge of the enterprise network.

### BRIEF DESCRIPTION OF THE DRAWINGS

The foregoing and other objects, features and advantages of the invention will be apparent from the following description of preferred example embodiments as well as illustrated in the accompanying drawings which reference characters refer to the same parts throughout.

FIG. 1 is a network overview with regard to the deployment of the T-HA, I-HA and the remote access scenarios using the T-HA.

FIG. 2 illustrates the traffic flows and tunneling for traffic from a remotely connecting mobile node to a correspondent node where the T-HA is employed, and direct routing is employed from the T-HA for incoming traffic.

FIG. 3 illustrates the traffic flows and tunneling for traffic from a remotely connecting mobile node to a correspondent node where the T-HA is employed, and reverse tunneling is employed for all traffic between the T-HA and the I-HA.

### DETAILED DESCRIPTION OF THE DRAWINGS

In the following description, for purposes of explanation and not limitation, specific details are set forth, such as particular embodiments, circuits, signal formats, techniques, etc. in order to provide a thorough understanding of the present invention. Although specific protocols are referred to for purposes of facilitating the description, the present invention is not necessarily limited to such specific protocols. However, it will be apparent to one skilled in the art that the present invention may be practiced in other embodiments that depart from these specific details. In other instances, detailed descriptions of well-known methods, devices, and circuits are omitted so as not to obscure the description of the present invention with unnecessary detail.

The present invention implements a mobile agent, called a Transfer Home Agent (T-HA) which, when deployed at the edge of an enterprise network, facilitates secure, seamless and near-optimal mobility for remotely connecting users, and user moving between external and internal networks (inside the intranet).

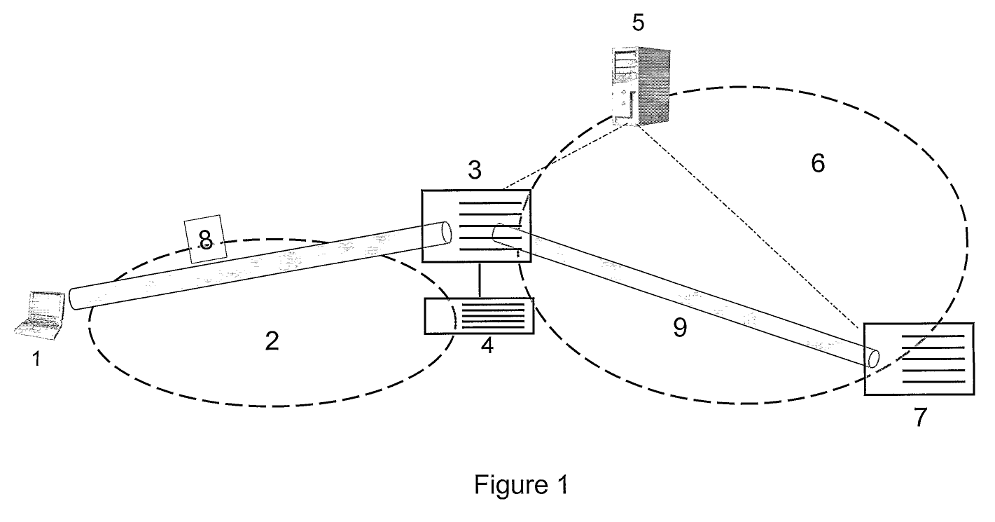

FIG. 1 presents a network overview of the deployment of a T-HA (3) in an enterprise network. It may be deployed connected directly towards the public Internet (2), or located in the DMZ, connected to the Internet, and the Intranet (6), via a firewall (4). The T-HA may alternatively have two separate interfaces for connection to the Internet and the Intranet, not needing for traffic to traverse the firewall again when going entering/exiting the intranet. The Mobile Node (1), in the figure is remotely connecting to the enterprise network, typically over a public access network (e.g. public WLAN hotspot, xDSL, WWAN . . . ). The Mobile Node tunnels traffic in an encrypted IPSec tunnel within a Mobile IP tunnel (IP or UDP encapsulation) back to the T-HA. The traffic is then forwarded or routed, either directly to its destination, or tunneled to the appropriate Internal Home Agent (7), from where it is forwarded to its destination. Traffic in the reverse direction, arrives on the home network for the remotely connected mobile node. The I-HA acts as a proxy for the mobile node, and the traffic is tunneled (IP or UDP encapsulation) back to the T-HA. At the T-HA it is decapsulated and tunneled in an IPSec/Mobile IP tunnel to the Mobile Node.

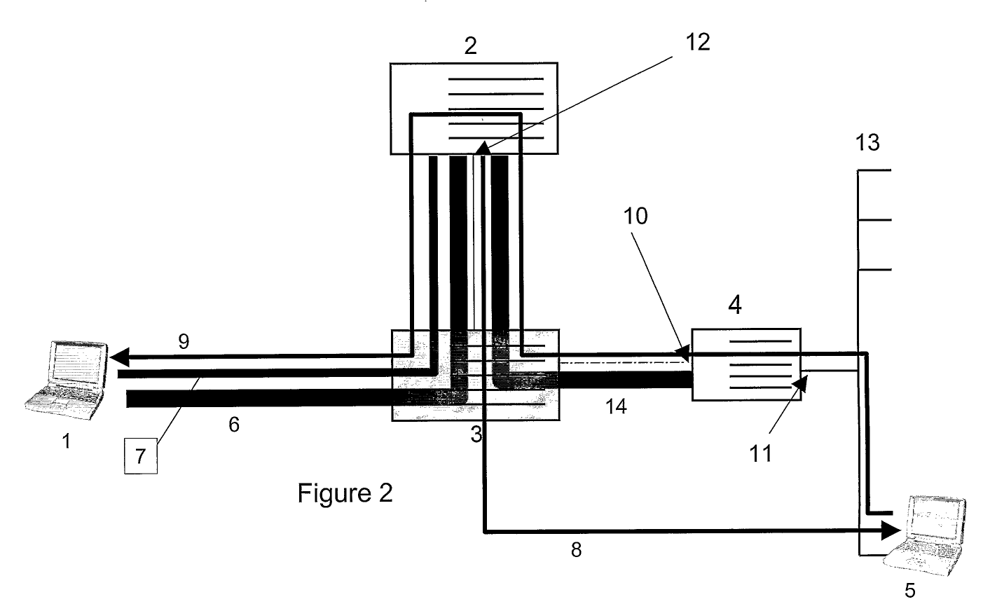

FIG. 2 illustrates the traffic flows and tunneling for a remotely connected mobile node (1) connecting back to the enterprise network and a correspondent node (5) inside the enterprise network, where reverse tunneling is not employed between the T-HA (2) and the I-HA (4). The mobile node establishes a mobile IP colocated registration back to the T-HA, using the ‘T-HA public IP address’ (12). Authentication of the connecting mobile node is based on its NAI and Mobile IP shared secret. On successful authentication at the T-HA, the MN is assigned an I-HA, and the registration request is forwarded onwards to the I-HA, using the ‘I-HA intranet IP address’ (10) as the destination. The I-HA will further authenticate the user and assign a MN IP address to use (if not pre-configured in the MN). After the successful Mobile IP registration, an IPSec tunnel (7) is established between the MN and the T-HA, inside the mobile IP tunnel (6). At the T-HA both tunnels are terminated, and the user traffic (9) is decrypted and decapsulated. The resulting IP packets are then routed onwards (8) to their destination—the Correspondent Node (5)—using normal Intranet routing. For the return trip, the packet will, based on normal routing mechanisms, appear on the MN's home network (13). As the MN is remotely connected, the I-HA will act as a proxy on its behalf. The I-HA will tunnel the return traffic to the T-HA inside an IP or UDP encapsulated tunnel (14). At the T-HA decapsulation occurs. The resulting IP packet is then encrypted and encapsulated again inside an IPSec (7) and Mobile IP (6) tunnel to the Mobile Node care-of address. At the mobile node, the decapsulated IP traffic results.

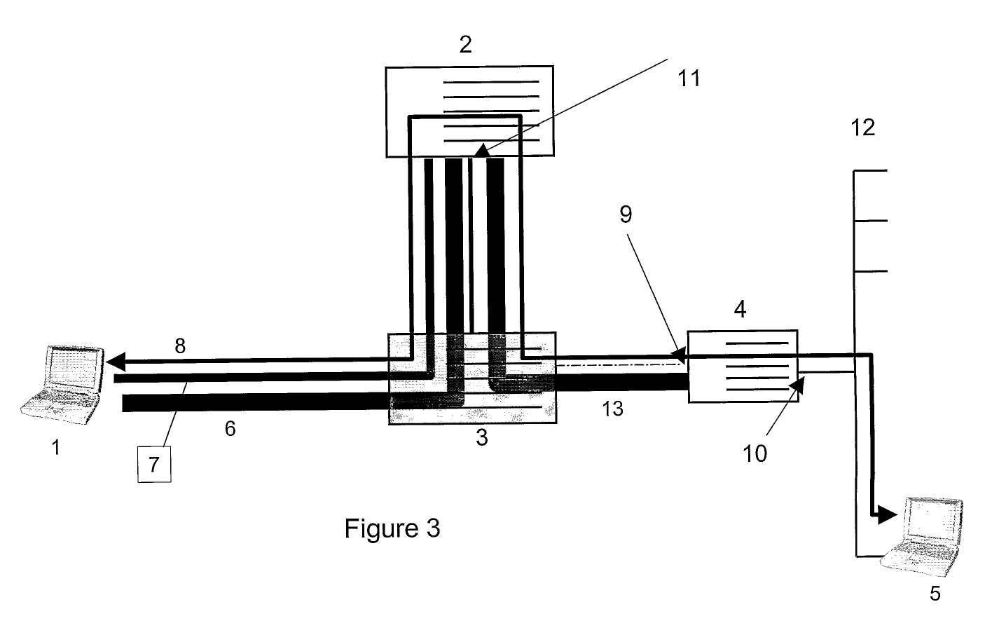

FIG. 3 illustrates the traffic flows and tunneling for a remotely connected mobile node (1) connecting back to a correspondent node (5) located in the enterprise network, where reverse tunneling is employed between the T-HA (2) and the I-HA (4). The mobile node establishes a mobile IP colocated registration back to the T-HA, using the ‘T-HA public IP address’ (11). Authentication of the connecting mobile node is based on its NAI and Mobile IP shared secret. On successful authentication at the T-HA, the MN is assigned an I-HA, and the registration request is forwarded onwards to the I-HA, using the ‘I-HA intranet IP address’ (9) as the destination. The I-HA will further authenticate the user and assign a MN IP address to use (if not pre-configured on the MN). After the successful Mobile IP registration, an IPSec tunnel (7) is established between the MN and the T-HA, inside the Mobile IP tunnel (6). At the T-HA both tunnels are terminated, and the user traffic (8) is decrypted and decapsulated. A further tunnel (IP or UDP encapsulation) (13) is then applied to the resulting IP packet, tunneling it onwards to the appropriate I-HA. At the I-HA the IP packet is then forwarded/routed onwards in accordance with normal intranet procedures.

### DESCRIPTION OF INVENTION

Overview

The solution and device presented in this document describes a deployment whereby a Transfer Home Agent (T-HA) device is deployed at the edge of an enterprise network, working with one or more internally located Home Agents (HA) to provide secure and seamless mobility for a mobile node roaming in the Internet, in the Intranet and between the two. The deployment is suited to scenarios where the intranet is routed, or multi-sited, or where there is more than 1 router hop between the internal home networks (where users connect when in the office) and the DMZ, or intranet/internet boundary, where the VPN termination for incoming traffic typically takes place.

FIG. 1 presents an overview of the deployment scenario. The T-HA is positioned connected to the Internet, or the IP access network. The T-HA can be deployed directly connected to the public access network or behind a firewall. In any case, it must be accessible uniquely on a public IP address, referred to herein as the ‘T-HA Public IP Address’, on port 434, as this is the requirement for mobile IP access to a mobile agent. The T-HA is configured to support termination of either IP encapsulated tunneling, as described in RFC 2003, referenced above, and UDP encapsulated tunneling, as described in RFC 3519, referenced above. IP encapsulated tunneling would typically be the default tunneling mechanism, however, UDP tunneling would be employed, based on detection by the T-HA that an intervening Network Address Translation (NAT) point has been passed for the incoming traffic. The mechanism for determining if UDP encapsulation should be used, and the establishment of it, is described in RFC 3519. Selection of the encapsulation mechanism can also be administratively configured. The T-HA also terminates IPSec VPN connectivity for a remotely connecting Mobile Node. IPSec VPN tunneling, within the Mobile IP tunnel is mandatory for remotely connecting mobile nodes, and non-IPSec tunneled incoming traffic will not be admitted by the T-HA. The T-HA is configured to require such VPN traffic on the incoming interface. In this way it behaves like other VPN gateway devices.

Towards the Intranet, the T-HA provides a number of configurable possibilities for transferring traffic onwards:
Traffic can be routed onwards, after the decryption and decapsulation on the incoming port.
IP encapsulate the traffic, after the decryption and decapsulation on the incoming port, tunneling it towards the internal HA associated with this user.
UDP encapsulate the traffic, after the decryption and decapsulation on the incoming port, tunneling it towards the internal HA associated with this user. This option may be configurable or dynamically determined based on an intervening NAT point being traversed between the T-HA and the I-HA.

In the T-HA, support is provided for authentication of the incoming remote users, based on NAI. The T-HA interacts with an external RADIUS server which provides the following functionality:
Authentication of the user;
Assignment of a I-HA;
Assignment of the T-HA (normally the same T-HA requesting the authentication)

In the case of the assignment of the I-HA, it may be statically configured in the RADIUS server for this user or selection of the appropriate I-HA to assign may involve more intelligent mechanisms, for example, based on determined location of the MN (based on source IP address lookup), availability or load of I-HAs, round-robin assignment from a pool of I-HAs, etc. The mechanisms for determining the assignment of the appropriate I-HA is outside the scope of this description. In the case of dynamic assignment of a T-HA, the MN will either have the T-HA dynamically assigned via some intermediate FA or, in the case of a colocated connection to the T-HA, a default (for initial connection) T-HA would be configured in the MN, to which it would initially connect. Then the authentication process at this T-HA may result in a new T-HA being assigned. The mechanisms for determining the assignment of the appropriate T-HA is outside the scope of this description.

Within the T-HA a mapping table is maintained to facilitate correct forwarding of traffic between the remotely connecting MN and the appropriate I-HA. To support this mapping, the binding between the MN and the T-HA is represented by the following details in the mapping:
MN's Careof Address
T-HA's Public IP Address
Encapsulation Type (IP encapsulation or UDP encapsulation)

The binding between the T-HA and the I-HA is represented in by the following details in the mapping:
T-HAs Public IP Address
I-HAs Intranet IP Address (as used by the T-HA to access it)
Encapsulation Type (IP encapsulation, UDP encapsulation or None)

Where the T-HA-I-HA binding Encapsulation Type is set to ‘None’, this indicates that traffic is routed normally from the T-HA to the I-HA, without any encapsulation being applied.

If the T-HA operation is configured for direct forwarding of traffic from remote users towards their destinations (i.e. T-HA-I-HA encapsulation is ‘None’), as shown in FIG. 2, then decapsulated/decrypted packets from the remote user will be routed, using normal IP routing, from the T-HA to their destinations. Where mandatory tunneling is employed between the T-HA and the I-HA for incoming remote connecting MN, as shown in FIG. 3, then the traffic will be encapsulated and forwarded towards the I-HA, at which point, after de-capsulation it will emerge on the home network, appearing like any other traffic originating on this physical network. Where direct forwarding is employed from the T-HA towards its destination, the IP packets may then be filtered by an intervening firewall or similar device. In this way remote access security can be ensured, combined with both internal/external mobility, yet allow the enterprise to apply full packet filtering, in keeping with its enterprise security policies.

In either forwarding case for incoming traffic, there will always be a return encapsulated tunnel between the I-HA and the T-HA. As the MN IP address of the remotely connecting user is topologically located on the home network, in the Intranet, all traffic destined for the user will arrive on this home network. However, as the MN is not there, the I-HA will act as a proxy for it, tunneling (IP or UDP encapsulation) all traffic destined for the MN to the T-HA at which point it is decapsulated and further encapsulated/encrypted towards the true location of the MN.

The design of the T-HA, with regard to mobile IP operation, is such that it appears like a regular HA for a remotely connecting MN, being accessible via its ‘T-HA public IP address’, not requiring any special interaction, different from a normal MN-HA interaction. From the I-HA side, the T-HA appears like a normal FA. To maintain this impression, the T-HA will deal with re-authentication of the MN, even as it connects towards the assigned I-HA. For this purpose, the T-HA will retain the shared-secret, returned during the RADIUS authentication, for the purpose of calculation of the hash for session authentication.

Accounting is supported at the T-HA for all traffic passing through it, and this can be based on either volume or time-based accounting. Full RADIUS-based accounting support is provided, and as the accounting messages include the care-of address of the MN, it is possible to determine on which access network the user is connecting, thus supporting differentiated tariffs.

The T-HA is also configurable to provide support for extended authentication, which facilitates incorporation of an extra level of authentication for remotely connecting mobile nodes, establishing a M-VPN session. The T-HA would, in this configuration, carry out the mobile IP registration procedure as discussed, selecting and registering towards the appropriate I-HA. In the setup of the IKE/IPSec tunnel to the T-HA, the T-HA, during the IKE negotiation, will indicate that extended authentication is required. The T-HA, at this point, sends an XAUTH request to the MN requesting a username & password. The MN will then, via its GUI request user entry of extended authentication information. This could entail entry of credentials from a one-time password token, or similar. Alternatively, this extended authentication could be via some MN configured local authentication device, e.g. USB token or smartcard, whereby the extended authentication would be without user interaction. The user credentials are sent back to the T-HA in an XAUTH response. The authentication can then be further carried out towards a RADIUS server, and/or potentially onwards to an external authentication service. This external service could be some legacy or separate authentication solution, potentially based on OTP mechanisms or similar, for example RSA SecurID.

On successful authentication the MN will proceed to IPSec SA negotiation. All traffic from the MN is blocked until successful negotiation of the IPSec SA, which cannot happen until the extended authentication is carried out. This mechanism ensures that legacy or extended authentication mechanisms can be included to further enhance the Mobile VPN remote access.

The aspects of the T-HA operation can be better understood by examining a number of usage scenarios.

Scenario: Mobile Node Connecting Remotely

FIG. 3 illustrates a Mobile Node connecting from a remote location, towards a T-HA, where tunneling is applied for incoming traffic, from the T-HA to the I-HA. Considering this usage scenario:
The mobile node connects from a remote location, outside the enterprise network. This connection is typically from a location such as dialup Internet access, public WLAN hotspot, home broadband or another enterprise network.
A Mobile IP Tunnel is negotiated towards the T-HA, using the T-HA Public IP address as the destination for the mobile IP registration request (RRQ). The NAI and an MD-5 hash of the MN shared secret will be included in this message. Typically in this case there will be no agent discovered by the MN on its local link, thus a colocated registration will be established and the care-of address used by the MN will be that which was assigned in the local access network.
The T-HA takes the information in the RRQ, and passes the NAI (& potentially the care-of address) towards the RADIUS Server. The RADIUS server will then respond to the T-HA, sending back the T-HA IP Address, I-HA IP Address (both the IP address visible to the T-HA and the IP address it has on the Home Network), the MN's Mobile IP shared secret and the MN's IKE shared secret.
The T-HA will then proceed to authenticate this incoming RRQ, using the shared-secret to generate a MD-5 hash to match against.
If authentication is successful, a new RRQ is generated by the T-HA for this registration request, and forwarded onwards to the assigned I-HA, using the I-HA Intranet IP address as the destination.
The I-HA will re-authenticate the request, in a similar way, and will also, if appropriate assign a MN IP address for the MN. This is based on if the MN IP address included in the registration request is 0.0.0.0, and is in accordance with IETF defined procedures for dynamic IP address assignment. After successful authentication, a RRP is sent back to the MN.
Once the Mobile IP registration is established, IKE negotiation will be initiated from the MN towards the T-HA IP address. During this negotiation, if extended authentication is required, the T-HA may send an XAUTH request message towards the MN requesting additional authentication.
At the MN, if XAUTH is required, a GUI dialog may be displayed requesting extended credentials entry. These are then sent back to the T-HA in a XAUTH response. At the T-HA authentication is carried out, towards the appropriate external authentication system.
If successful extended authentication is carried out, then IPSec SA establishment is carried out between the MN and the T-HA, after which traffic can flow.
The T-HA will maintain a mapping table entry for this MN connection towards the appropriate I-HA.
Traffic from the Mobile Node will arrive at the T-HA in an IPSec tunnel inside a Mobile IP tunnel (IP or UDP encapsulated). Decapsulation & decryption will take place.
The mapping table will then be used to determine the treatment of this packet, with it being encapsulated (if appropriate) and forwarded towards the I-HA or forwarded directly towards its destination, in the case where no T-HA-I-HA encapsulation is employed.
Traffic from the Home Network towards the MN is encapsulated at the I-HA, which proxies on behalf of the remotely located MN on the Home Network, and forwarded back to the T-HA.
At the T-HA, the traffic is decapsulated, and based on the mapping table entry, encrypted and encapsulated toward the MN.
   Scenario: Mobile Node Moving to its Home Network

The T-HA plays a central role in the provision of a mobility anchor point, and a security termination point for remotely connecting mobile nodes. When the MN moves home, onto its Home Network, then the T-HA is no longer in the loop. Consider the following scenario:
MN connects on Home Network.
MN sends out a mobile IP solicitation to determine if any agent is present.
I-HA will send out agent advertisement, and MN will determine, using standard mobile IP procedures, that this is its Home Agent.
The MN will then proceed to de-register with the I-HA.
Traffic will flow as normal to/from the MN, with no tunneling or I-HA or T-HA traversal.
In the T-HA the mobile IP and IKE/IPSec SAs will time-out, or will be re-negotiated should the MN move back to be remotely connecting, through the T-HA.
   Impact on the Mobile Node

The mobile node, when operating in a Mobile VPN environment, provides both IKE/IPSec VPN client functionality and also mobile IP MN functionality. The MN is configured either manually or dynamically at connection point with a MN IP address. This is the fixed unchanging IP address which is used by all applications running on the MN platform. This unchanging nature of the IP address means that any underlying IP address changes which take place, due to location or connectivity changes, are hidden from the applications. As a MN moves it may get a new care-of address assigned to it. In the case of a FA being employed, this is an IP address on the FA, which the MN tells the HA to use when it needs to send traffic to it. In the case of no FA being used, the care-of address is typically some locally DHCP assigned IP address which the MN gets from the local network on which it connects. In this case the HA is instructed, in the registration procedure, to send all traffic destined for the MN to this care-of address (tunneled as appropriate).

For the MN to function correctly when communicating with the T-HA, it needs to be configured (statically or dynamically) with the following information:
MN IP address
T-HA Public IP address
I-HA Private IP address
Mobile IP Shared Secret
IKE Shared Secret

The MN IP address is the IP address that is either configured on statically on the MN or assigned dynamically at registration time, and used as the source IP address for all application traffic on the MN. The T-HA public IP address is the address used by the MN, when connecting remotely, for sending traffic towards, both mobile IP control messages and encapsulated traffic. The I-HA Private IP address is the address of the I-HA on the interface connected to the home network. This IP address is used by the MN to determine when it is connected on its home network. The mobile IP and IKE shared secrets are used for the mobile IP authentications and the IKE/IPSec SA establishment.

In relation to the configuration of the T-HA Public IP Address in the MN, there will likely be a ‘default’ address configured to which all remote registration requests are initially sent. Should dynamic assignment of T-HA be configured in the solution, then the MN may receive an indication of a new T-HA Public IP Address to use, and the MN will attempt the registration again, but this time towards the newly assigned T-HA.

When the MN is outside the enterprise intranet it only ever uses the T-HA IP address as the destination for all mobile IP control and data traffic. However, when the MN moves into the Intranet, the T-HA is no longer in the traffic path, so is no longer involved. If the MN detects that it is on its home network, it will de-register with its home network.

If the MN is on the intranet, but not on its home network, if it can detect that it is on its intranet—potentially by some matching of DNS suffix in the DHCP-assigned IP address, or similar—it may attempt a colocated registration towards the I-HA private IP address. In this case traffic is tunneled directly to the I-HA, potentially without security (if deemed appropriate) and even in this case, the T-HA is not in the traffic path. This scenario is mentioned for informational purposes and is not considered part of this patent application.

1. A mobile agent device in a Mobile Virtual Private Network, said device comprising:
a. termination of Mobile IP tunnel from a remotely connecting Mobile Node;
b. termination of an IPSec VPN tunnel from the remotely connecting Mobile Node;
c. dynamic Selection of Internal Mobile IP Home Agent based on user Authentication;
d. tunneling of traffic to and/or from the assigned Internal Mobile Home Agent for this Mobile Node; and
e. provision of extended authentication, after Mobile IP connection establishment, and during the VPN negotiation phase, based on extra user credentials, one-time-password mechanism or similar.

2. The device of claim 1, wherein the mobile agent device appears as a Mobile IP Foreign Agent towards the Internal Home Agent.

3. The device of claim 1, wherein the mobile agent device appears as a Mobile IP Home Agent towards the remotely connecting Mobile Node.

4. The device of claim 1, wherein the mobile agent device provides a dynamically assigned Mobile IP address to the Mobile Node, if requested to do so by the Mobile Node.

5. The device of claim 1, wherein the mobile agent device provides a termination point for IKE & IPSec VPN connections from a remotely connecting Mobile Node.

6. The device of claim 1, wherein IP encapsulated tunneling is used for transfer of traffic between the mobile agent device and the Internal Home Agent.

7. The device recited in claim 1, wherein UDP encapsulated tunneling is used for transfer of traffic between the mobile agent device and the Internal Home Agent.

8. The device of claim 1, wherein traffic can be routed directly from the mobile agent device towards its destination, on receipt from the mobile node.

9. The device of claim 1, wherein IP encapsulated tunneling is used for transfer of traffic between the mobile node and the mobile agent device.

10. The device claim 1, wherein UDP encapsulated tunneling is used for transfer of traffic between the mobile node and the mobile agent device.

11. The device claim 9, wherein IPSec tunneling is used for protection of the transfer of traffic between the mobile node and the mobile agent device, within said encapsulation.

12. The device of claim 1, further comprising restriction of user access to the internal home agent or internal network, until extended user authentication is carried out.

13. The device of claim 1, further comprising time and volume based accounting is carried out a per Mobile Node basis.

14. (canceled)

15. The device of claim 10, wherein IPSec tunneling is used for protection of the transfer of traffic between the mobile node and the mobile agent device, within said encapsulation.
